(19) United States
(12) Patent Application Publication
(10) Pub. No.: US 2025/0164601 A1
(43) Pub. Date: May 22, 2025

(54) METHOD FOR IDENTIFYING INNER AND OUTER TIRE PRESSURE SENSORS

(71) Applicants: TUNG-FU HSIEH, TAIPEI CITY (TW); HSIAO-CHEN HUANG, TAIPEI CITY (TW)

(72) Inventors: TUNG-FU HSIEH, TAIPEI CITY (TW); HSIAO-CHEN HUANG, TAIPEI CITY (TW)

(21) Appl. No.: 18/950,193

(22) Filed: Nov. 18, 2024

(30) Foreign Application Priority Data
Nov. 21, 2023 (TW) 112144968

(51) Int. Cl. G01S 5/02; B60C 23/04; G01L 17/00

(52) U.S. Cl. CPC G01S 5/0269; B60C 23/0416; G01L 17/00

(57) ABSTRACT

A method for identifying inner and outer tire pressure sensors, which includes the following steps: Signal Reception Step, Signal Strength Summation Step, and Inner and Outer Wheel Identification Step. The vehicle main unit receiving the first inner wheel detection signal strength total value and the first outer wheel detection signal strength total value, and compares their magnitudes. The larger value indicates the inner wheel, while the smaller value indicates the outer wheel. The vehicle main unit identifies inner and outer wheels by having tire pressure sensors read and recognize the signal strength of tire pressure sensors in mirror-image positions. Compared to traditional methods, this approach can more accurately identify tire pressure sensors on inner and outer wheels.

### BACKGROUND OF THE INVENTION

### 1. Fields of the Invention

The present invention relates to a method for identifying inner and outer tire pressure sensors, applied to vehicles with inner and outer wheels such as trucks and tractor-trailers, to facilitate the vehicle main unit in distinguishing between the tire pressure sensors of inner and outer wheels.

### 2. Descriptions of Related Art

Tire pressure values are crucial indicators of whether a vehicle can be driven safely. With technological advancements, the methods for detecting tire pressure have also improved significantly. In the past, tire pressure could only be measured manually, wheel by wheel. Now, various electronic devices automatically measure and transmit the data to monitoring screens for display, which has made the process considerably more convenient.

Among the more common electronic devices are tire pressure sensors. These sensors contain components related to tire pressure detection, coupled with battery-powered electronic modules that can connect and share information with the matching vehicle main unit so that users are able to view tire pressure values on the vehicle main unit. Generally, for conventional vehicles with four wheels, four tire pressure sensors need to be installed separately on the left front wheel, right front wheel, left rear wheel, and right rear wheel. However, as these four tire pressure sensors are identical products, it is difficult for the vehicle main unit to identify which value corresponds to which wheel (left front, right front, left rear, or right rear). Therefore, the standard approach is for the main unit to collect rotation direction information and wireless signal strength from each tire pressure sensor, thereby determining the position of each sensor.

However, for vehicles with inner and outer wheels, such as trucks and tractor-trailers, the aforementioned method struggles to distinguish between inner and outer wheels due to their close proximity. This often leads to misidentification by the main unit. Therefore, it is essential for technicians in this field to develop a method for identifying tire pressure sensors on inner and outer wheels. the conventional

The present invention intends to provide a method for identifying inner and outer tire pressure sensors, to eliminate the shortcomings mentioned above.

### SUMMARY OF THE INVENTION

The present invention relates to a method for identifying inner and outer tire pressure sensors, and comprises the following steps:

Signal Reception Step: a first wheel set and a second wheel set being in mirror configuration, the first wheel set including a first inner tire pressure sensor and a first outer tire pressure sensor, the second wheel set including a second inner tire pressure sensor and a second outer tire pressure sensor, the first inner tire pressure sensor reading and identifying a signal strength of each of the second inner tire pressure sensor and the second outer tire pressure sensor, the first outer tire pressure sensor reading and identifying the signal strengths of the second inner tire pressure sensor and the second outer tire pressure sensor;

Signal Strength Summation Step: the first inner tire pressure sensor summing up the signal strengths read from the second inner tire pressure sensor and the second outer tire pressure sensor to calculate a first inner wheel detection signal strength total value, the first outer tire pressure sensor summing up the signal strengths read from the second inner tire pressure sensor and the second outer tire pressure sensor to calculate a first outer wheel detection signal strength total value, and

Inner and Outer Wheel Identification Step: a vehicle main unit receiving the first inner wheel detection signal strength total value and the first outer wheel detection signal strength total value, and comparing the first inner wheel detection signal strength total value and the first outer wheel detection signal strength total value, one with the larger value being identified as the inner wheel, and the other one with the smaller value being identified as the outer wheel.

The present invention also provide another method for identifying inner and outer tire pressure sensors, and comprises the following steps:

Signal Reception Step: a first wheel set and a second wheel set being in mirror configuration, the first wheel set including a first inner tire pressure sensor and a first outer tire pressure sensor, the second wheel set including a second inner tire pressure sensor and a second outer tire pressure sensor, the first inner tire pressure sensor reading and identifying signal strengths of the second inner tire pressure sensor and the second outer tire pressure sensor, the first outer tire pressure sensor reading and identifying the signal strengths of the second inner tire pressure sensor and the second outer tire pressure sensor, and

Inner and Outer Wheel Identification Step: the first inner tire pressure sensor and the first outer tire pressure sensor respectively transmitting an identified signal strength value to the vehicle main unit, the vehicle main unit separately comparing the two identified signal strength values, one with the larger value being identified as the inner wheel, and the other one with the smaller value being identified as the outer wheel, the comparison results then being cross-checked to confirm whether a determination of inner and outer wheels is correct.

The primary object of the present invention is to provide a method for the main unit of a vehicle to identify inner and outer wheels by having tire pressure sensors read and recognize the signal strength of tire pressure sensors in mirror-image positions. Compared to traditional methods, this approach can more accurately identify tire pressure sensors on inner and outer wheels.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a step diagram of the first embodiment of the present invention;

FIG. 2 is a block diagram of the structure of the first embodiment of the present invention;

FIG. 3 is a step diagram of another embodiment of the present invention;

FIG. 4 is a block diagram of the structure of another embodiment of the present invention;

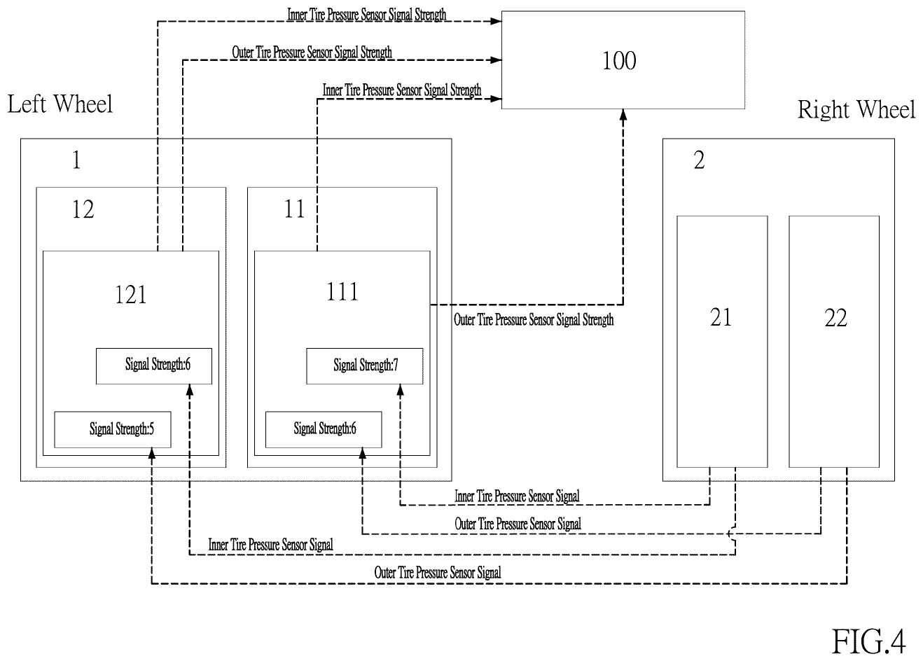

FIG. 5 is a first scenario diagram explaining how the vehicle main unit determines tire pressure sensors for each wheel set, and

FIG. 6 is a second scenario diagram explaining how the vehicle main unit determines tire pressure sensors for each wheel set.

### DETAILED DESCRIPTION OF THE PREFERRED EMBODIMENT

The method of the present invention follows after the conventional tire pressure sensor determination steps. In these conventional steps, the vehicle main unit first locks onto the tire pressure sensors of the left and right wheel sets, then proceeds to determine the front and rear wheels and the rotation direction of each tire. Following conventional technology, it then deduces the multiple tire pressure sensors installed on the left and right wheel sets. The subsequent step is to identify the inner and outer tire pressure sensors, which is the determination step provided by the present invention.

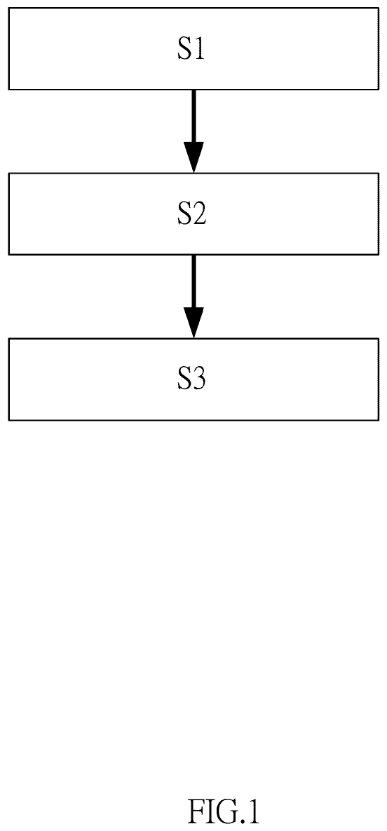

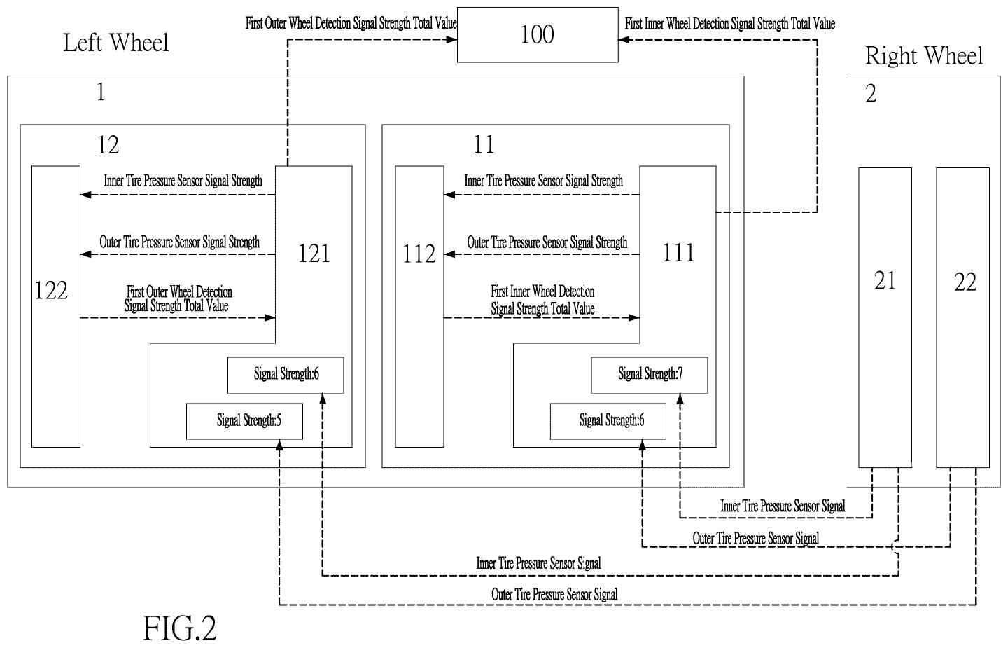

Referring to FIGS. 1 to 2, the method for identifying inner and outer tire pressure sensors of the present invention comprises the following steps:

Signal Reception Step S1:

A first wheel set 1 and a second wheel set 2 are in mirror configuration, wherein the first wheel set 1 including a first inner tire pressure sensor 11 and a first outer tire pressure sensor 12. The second wheel set 2 includes a second inner tire pressure sensor 21 and a second outer tire pressure sensor 22. The first inner tire pressure sensor 11 reads and identifies a signal strength of each of the second inner tire pressure sensor 21 and the second outer tire pressure sensor 22. The first outer tire pressure sensor 12 reads and identifies the signal strengths of the second inner tire pressure sensor 21 and the second outer tire pressure sensor 22.

Signal Strength Summation Step S2:

The first inner tire pressure sensor 11 sums up the signal strengths read from the second inner tire pressure sensor 21 and the second outer tire pressure sensor 22 to calculate a first inner wheel detection signal strength total value, and the first outer tire pressure sensor 12 sums up the signal strengths read from the second inner tire pressure sensor 21 and the second outer tire pressure sensor 22 to calculate a first outer wheel detection signal strength total value.

Inner and Outer Wheel Identification Step S3: A vehicle main unit 100 receives the first inner wheel detection signal strength total value and the first outer wheel detection signal strength total value, and then compares the first inner wheel detection signal strength total value and the first outer wheel detection signal strength total value. One with the larger value is identified as the inner wheel, and the other one with the smaller value is identified as the outer wheel.

The first inner tire pressure sensor 11 uses a first inner wheel signal transceiver module 111 to receive signals from the second inner tire pressure sensor 21 and the second outer tire pressure sensor 22 so as to determine their signal strengths. It can also be used to transmit the first inner wheel detection signal strength total value to the vehicle main unit 100. The first inner tire pressure sensor 11 uses a first inner wheel signal summation module 112 to calculate the signal strengths received from the second inner tire pressure sensor 21 and the second outer tire pressure sensor 22.

The first outer tire pressure sensor 12 uses a first outer wheel signal transceiver module 121 to receive signals from the second inner tire pressure sensor 21 and the second outer tire pressure sensor 22, and thereby determines their signal strengths. It can also be used to transmit the first outer wheel detection signal strength total value to the vehicle main unit 100. The first outer tire pressure sensor 12 uses a first outer wheel signal summation module 122 to calculate the signal strengths received from the second inner tire pressure sensor 21 and the second outer tire pressure sensor 22.

Continuing from the above content, specifically explaining why the vehicle main unit 100 can identify inner and outer wheels by comparing the magnitudes of the first inner wheel detection signal strength total value and the first outer wheel detection signal strength total value. Taking FIG. 2 as an example, where the first wheel set 1 is the left wheel and the second wheel set 2 is the right wheel, as shown in the diagram that the first inner tire pressure sensor 11 is closer to the second inner tire pressure sensor 21 and second outer tire pressure sensor 22 compared to the first outer tire pressure sensor 12. Therefore, the signal strength received by the first inner tire pressure sensor 11 will be stronger. To facilitate understanding of the present invention, numbers are used to represent signal strengths, where larger numbers indicate stronger signals and smaller numbers indicate weaker signals. For example, if the signal strength received by the first inner tire pressure sensor 11 from the second inner tire pressure sensor 21 is “7”, and the signal strength received from the second outer tire pressure sensor 22 is “6”, then the first inner wheel detection signal strength total value would be “13”. Meanwhile, if the signal strength received by the first outer tire pressure sensor 12 from the second inner tire pressure sensor 21 is “6”, and the signal strength received from the second outer tire pressure sensor 22 is “5”, then the first outer wheel detection signal strength total value would be “11”. Therefore, after comparing these two values, the larger value indicates the inner wheel, while the smaller value indicates the outer wheel.

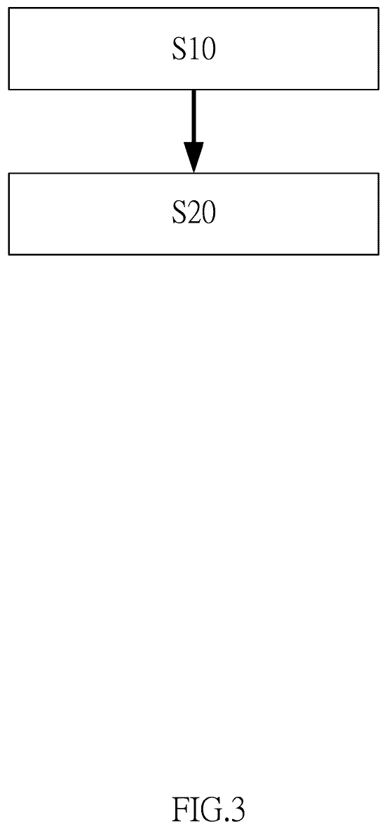

As shown in FIGS. 2 and 3, the present invention also has another method that requires only the Signal Reception Step S10 and Inner and Outer Wheel Identification Step S20, without needing the Signal Strength Summation step. For example, if the signal strength received by the first inner tire pressure sensor 11 from the second inner tire pressure sensor 21 is “7”, and the signal strength received from the second outer tire pressure sensor 22 is “6”, after transmitting this data to the vehicle main unit 100, the vehicle main unit 100 can identify that the second inner tire pressure sensor 21 has a stronger signal and therefore is positioned on the inner wheel, while the second outer tire pressure sensor 22 has a weaker signal and therefore is positioned on the outer wheel.

Similarly, if the signal strength received by the first outer tire pressure sensor 12 from the second inner tire pressure sensor 21 is “6”, and the signal strength received from the second outer tire pressure sensor 22 is “5”, after transmitting this data to the vehicle main unit 100, the vehicle main unit 100 can identify that the second inner tire pressure sensor 21 has a stronger signal and therefore is positioned on the inner wheel, while the second outer tire pressure sensor 22 has a weaker signal and therefore is positioned on the outer wheel. Subsequently, the vehicle main unit 100 can confirm the final result by cross-checking these two sets of comparison results.

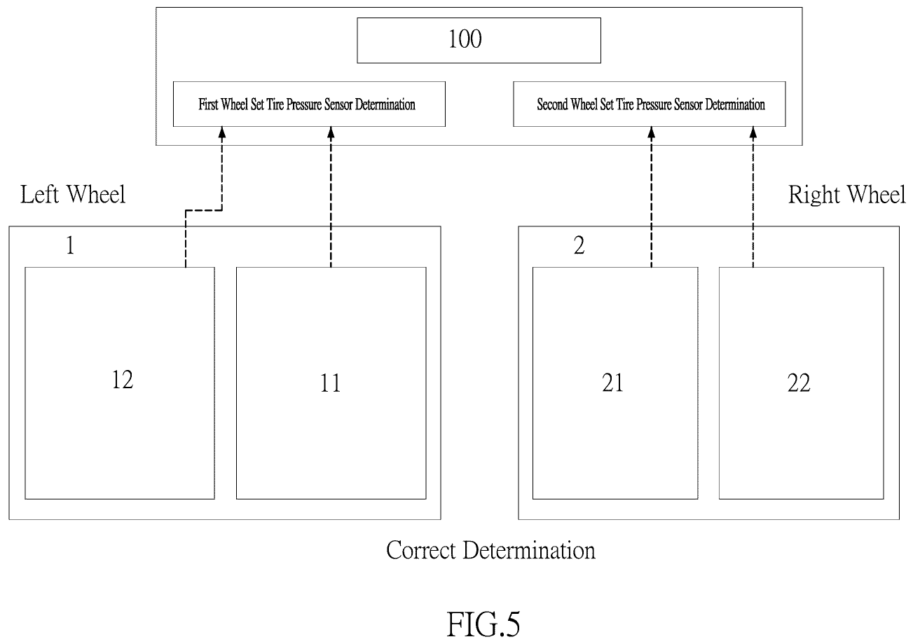

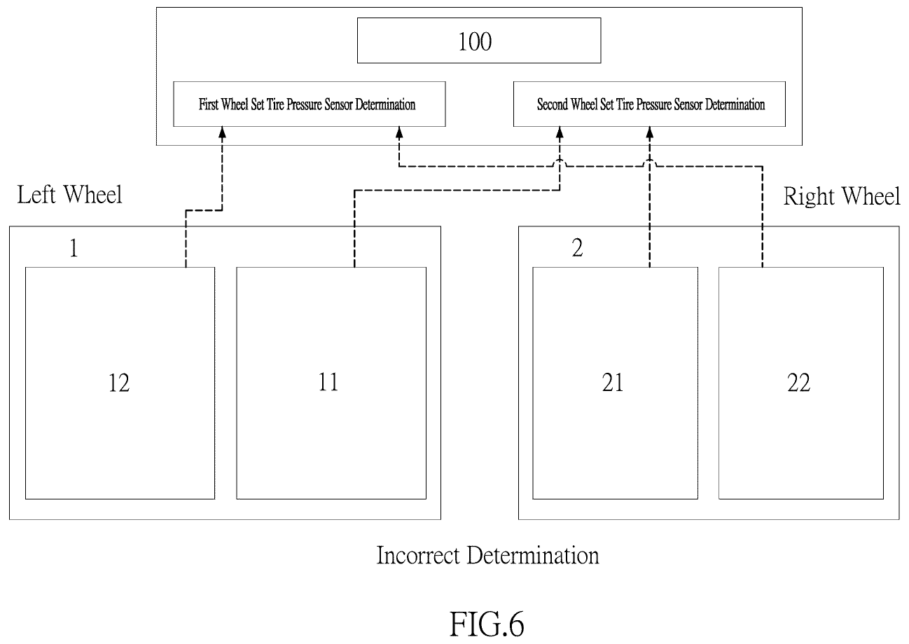

Furthermore, when the vehicle main unit 100 follows the steps of the present invention, it first determines (for example: by using clockwise and counterclockwise rotation directions) which wheel set each tire pressure sensor belongs to. As shown in FIG. 5, the present represents the situation where the vehicle main unit 100 correctly determines that the first inner tire pressure sensor 11 and first outer tire pressure sensor 12 belong to the first wheel set 1, and the second inner tire pressure sensor 21 and second outer tire pressure sensor 22 belong to the second wheel set 2. However, in practice, incorrect determinations can occur, as shown in FIG. 6, where the vehicle main unit 100 mistakenly determines that the first inner tire pressure sensor 11 belongs to the second wheel set 2, and incorrectly determines that the second inner tire pressure sensor 21 belongs to the first wheel set 1. Therefore, the present invention further provides a method for error elimination.

Taking the first method of the present invention as an example, the vehicle main unit 100 has built-in reasonable range values for the first inner wheel detection signal strength total value and the first outer wheel detection signal strength total value. If either of these values falls outside the reasonable range values, the vehicle main unit 1 will re-match the first inner tire pressure sensor 11, the first outer tire pressure sensor 12, the second inner tire pressure sensor 21, and the second outer tire pressure sensor 22, and restart the entire process from Signal Reception Step S1, until both the first inner wheel detection signal strength total value and the first outer wheel detection signal strength total value fall within the reasonable range values.

For example, as shown in FIG. 2, when the vehicle main unit 100 correctly determines the signals of each wheel set as shown in FIG. 5, the feedback signal strength total value from the first inner tire pressure sensor 11 should be 13. Considering normal signal strength fluctuations, its reasonable range should be 12˜14. However, when incorrect determinations occur as shown in FIG. 6, the signal strength total value received by the vehicle main unit will deviate from this range. For example, if it reads a signal strength of 20, this has already deviated from the reasonable range for the first inner tire pressure sensor signal strength total value, thus allowing the vehicle main unit 100 to determine that there is a signal matching error.

To make error signal elimination more precise, the present invention further provides another method where the vehicle main unit 100 has built-in reasonable range values for the signal strengths of inner and outer tire pressure sensor signals received respectively by the first outer tire pressure sensor 12 and the first inner tire pressure sensor 11. In this method, when the vehicle main unit 100 receives the first inner wheel signal strength total value and the first outer wheel signal strength total value, it also receives the individual data used for summation. If any of these values falls outside the reasonable range values, the entire process will restart from Signal Reception Step S1 until all signal strength values of inner and outer tire pressure sensor signals received by both the first inner tire pressure sensor 11 and first outer tire pressure sensor 12 fall within the reasonable range values.

For example, for the first inner tire pressure sensor 11, the signal strength from the second inner tire pressure sensor 21 should be between 6.5˜7.5. If it receives a signal strength outside this 6.5˜7.5 range, it can be determined that a signal reception error has occurred.

While we have shown and described the embodiment in accordance with the present invention, it should be clear to those skilled in the art that further embodiments may be made without departing from the scope of the present invention.

What is claimed is:

1. A method for identifying inner and outer tire pressure sensors, comprising the following steps:
Signal Reception Step (S1): a first wheel set (1) and a second wheel set (2) being in mirror configuration, the first wheel set (1) including a first inner tire pressure sensor (11) and a first outer tire pressure sensor (12), the second wheel set (2) including a second inner tire pressure sensor (21) and a second outer tire pressure sensor (22), the first inner tire pressure sensor (11) reading and identifying a signal strength of each of the second inner tire pressure sensor (21) and the second outer tire pressure sensor (22), the first outer tire pressure sensor (12) reading and identifying the signal strengths of the second inner tire pressure sensor (21) and the second outer tire pressure sensor (22);
Signal Strength Summation Step (S2): the first inner tire pressure sensor (11) summing up the signal strengths read from the second inner tire pressure sensor (21) and the second outer tire pressure sensor (22) to calculate a first inner wheel detection signal strength total value, the first outer tire pressure sensor (12) summing up the signal strengths read from the second inner tire pressure sensor (21) and the second outer tire pressure sensor (22) to calculate a first outer wheel detection signal strength total value, and
Inner and Outer Wheel Identification Step (S3): a vehicle main unit (100) receiving the first inner wheel detection signal strength total value and the first outer wheel detection signal strength total value, and comparing the first inner wheel detection signal strength total value and the first outer wheel detection signal strength total value, one with the larger value being identified as the inner wheel, and the other one with the smaller value being identified as the outer wheel.

2. The method as claimed in claim 1, wherein the vehicle main unit (100) has built-in reasonable range values for the first inner wheel detection signal strength total value and the first outer wheel detection signal strength total value, when either the first inner wheel detection signal strength total value or the first outer wheel detection signal strength total value falls outside the reasonable range values, the vehicle main unit (100) re-matches the first inner tire pressure sensor (11), the first outer tire pressure sensor (12), the second inner tire pressure sensor (21), the second outer tire pressure sensor (22), and restarts the process from the Signal Reception Step (S1) until both the first inner wheel detection signal strength total value and the first outer wheel detection signal strength total value fall within the reasonable range values.

3. The method as claimed in claim 1, wherein the vehicle main unit (100) has built-in reasonable range values for the signal strengths of inner tire pressure sensor signals and outer tire pressure sensor signals received respectively by the first outer tire pressure sensor (12) and the first inner tire pressure sensor (11), when any of the aforementioned values falls outside the reasonable range values, the vehicle main unit (100) re-matches the first inner tire pressure sensor (11), the first outer tire pressure sensor (12), the second inner tire pressure sensor (21), and the second outer tire pressure sensor (22), and restarts the process from the Signal Reception Step (S1) until the signal strength values of inner tire pressure sensor signals and outer tire pressure sensor signals received by both the first inner tire pressure sensor (11) and first outer tire pressure sensor (12) fall within the reasonable range values.

4. A method for identifying inner and outer tire pressure sensors, comprising the following steps:
Signal Reception Step (S10): a first wheel set (1) and a second wheel set (2) being in mirror configuration, the first wheel set (1) including a first inner tire pressure sensor (11) and a first outer tire pressure sensor (12), the second wheel set (2) including a second inner tire pressure sensor (21) and a second outer tire pressure sensor (22), the first inner tire pressure sensor (11) reading and identifying signal strengths of the second inner tire pressure sensor (21) and the second outer tire pressure sensor (22), the first outer tire pressure sensor (12) reading and identifying the signal strengths of the second inner tire pressure sensor (21) and the second outer tire pressure sensor (22), and
Inner and Outer Wheel Identification Step (S20): the first inner tire pressure sensor (11) and the first outer tire pressure sensor (12) respectively transmitting an identified signal strength value to the vehicle main unit (100), the vehicle main unit (100) separately comparing the two identified signal strength values, one with the larger value being identified as the inner wheel, and the other one with the smaller value being identified as the outer wheel, the comparison results then being cross-checked to confirm whether a determination of inner and outer wheels is correct.
